(19) United States
(12) Patent Application Publication
(10) Pub. No.: US 2022/0144250 A1
(43) Pub. Date: May 12, 2022

(54) PARKING ASSIST APPARATUS AND PARKING ASSIST METHOD

(71) Applicant: DENSO CORPORATION, Kariya-city (JP)

(72) Inventor: Takamasa HIDAKA, Kariya-city (JP)

(21) Appl. No.: 17/581,379

(22) Filed: Jan. 21, 2022

Related U.S. Application Data
(63) Continuation of application No. PCT/JP2020/027274, filed on Jul. 13, 2020.

(30) Foreign Application Priority Data
Jul. 26, 2019 (JP) 2019-138003
Sep. 30, 2019 (JP) 2019-179966

(51) Int. Cl. B60W 30/06; B60W 60/00; B60W 50/02; B60W 50/029

(52) U.S. Cl. CPC B60W 30/06; B60W 50/029; B60W 50/0225; B60W 60/001

(57) ABSTRACT

A parking assist apparatus generates: a guidance route for each of multiple self-driving vehicles existing in a parking lot such that the guidance routes of the self-driving vehicles do not overlap with one another, and transmit the guidance route to the corresponding self-driving vehicle, which plans to travel along the guidance route, when the guidance route is generated for the corresponding self-driving vehicle. When the guidance route of one self-driving vehicle to be generated overlaps with the guidance route of another one self-driving vehicle that has been generated, the route generation unit cancels generation of the guidance route for the one self-driving vehicle.

### CROSS REFERENCE TO RELATED APPLICATIONS

The present application is a continuation application of International Patent Application No. PCT/JP2020/027274 filed on Jul. 13, 2020, which designated the U.S. and claims the benefit of priority from Japanese Patent Application No. 2019-138003 filed on Jul. 26, 2019 and Japanese Patent Application No. 2019-179966 filed on Sep. 30, 2019. The entire disclosures of all of the above applications are incorporated herein by reference.

### TECHNICAL FIELD

The present disclosure relates to a parking assist apparatus configured to assist parking of a self-driving vehicle in a parking lot, and a parking assist method executed by the parking assist apparatus.

### BACKGROUND

Conventionally, a management device that automatically determines a travel route to an empty parking space in a parking lot and controls a self-driving vehicle to the parking space is known.

### SUMMARY

The present disclosure provides a parking assist apparatus that generates: a guidance route for each of multiple self-driving vehicles existing in a parking lot such that the guidance routes of the self-driving vehicles do not overlap with one another, and transmit the guidance route to the corresponding self-driving vehicle, which plans to travel along the guidance route, when the guidance route is generated for the corresponding self-driving vehicle. When the guidance route of one self-driving vehicle to be generated overlaps with the guidance route of another one self-driving vehicle that has been generated, the route generation unit cancels generation of the guidance route for the one self-driving vehicle.

### BRIEF DESCRIPTION OF DRAWINGS

Objects, features and advantages of the present disclosure will become apparent from the following detailed description made with reference to the accompanying drawings. In the drawings:

FIG. 1 is a block diagram illustrating a configuration of a parking assist system;

FIG. 2 is a plan diagram illustrating an example of a parking lot;

FIG. 3 is a flowchart illustrating an example of a parking lot entrance or parking lot exit of a vehicle;

FIG. 4 is a flowchart illustrating an example of a traveling route generation process;

FIG. 5 is a plan diagram illustrating an example of a parking lot;

FIG. 6 is a block diagram illustrating a configuration of a parking assist system;

FIG. 7 is a functional block diagram illustrating a controller of a management device;

FIG. 8 is a flowchart illustrating a parking setting process executed by the management device;

FIG. 9 is a flowchart illustrating a non-overlap entrance process included in the parking setting process;

FIG. 10 is a flowchart illustrating an automatic parking process executed by a self-driving vehicle;

FIG. 11 is a flowchart illustrating an exit setting process executed by the management device;

FIG. 12 is a flowchart illustrating a non-overlap exit process included in the exit setting process;

FIG. 13 is a flowchart illustrating an automatic exit process executed by a self-driving vehicle;

FIG. 14A is a diagram conceptually illustrating a case where all of the paths in the parking lot are available;

FIG. 14B is a diagram conceptually illustrating available paths when a different vehicle is traveling in the parking lot;

FIG. 14C is a diagram conceptually illustrating whether a pat is available when a non-overlapping guidance route is set; and

FIG. 14D is a diagram conceptually illustrating release of a guidance route that has been traveled.

### DETAILED DESCRIPTION

There has been known a management device that automatically determines a travel route to an empty parking space in a parking lot, and uses the self-driving function of a self-driving vehicle to guide the self-driving vehicle between a boarding area/alighting area of an occupant and a parking space of the self-driving vehicle.

Based on the inventor's detailed study and examination, in some cases, a parking management device fails to obtain an accurate position of the self-driving vehicle due to, for example, communication delay, and thus, may fail to safely guide multiple self-driving vehicles to respective parking spaces or to the boarding area/alighting area. This is because there is a difference between an actual current position of the self-driving vehicle and position information obtained by the parking management device.

According to an aspect of the present disclosure, a parking assist apparatus, which assisting a vehicle parking, includes: a route generation unit generating a guidance route for each of a plurality of self-driving vehicles existing in a parking lot, the guidance routes of the plurality of self-driving vehicles being generated to not overlap with one another, each of the plurality of self-driving vehicles being capable of executing a self-driving along the corresponding guidance route; and a route transmission unit transmitting the guidance route to the corresponding self-driving vehicle, which plans to travel along the guidance route, when the guidance route is generated for the corresponding self-driving vehicle.

When the guidance route of one of the plurality of self-driving vehicles to be generated overlaps with the guidance route of another one of the plurality of self-driving vehicles that has been generated, the route generation unit cancels a generation of the guidance route for the one of the plurality of self-driving vehicles.

According to the above apparatus, the guidance route of one self-driving vehicle is generated to not overlap with the guidance route of another self-driving vehicle. Thus, the self-driving vehicles in the parking lot can be guided to target positions with improved safety.

(System Configuration)

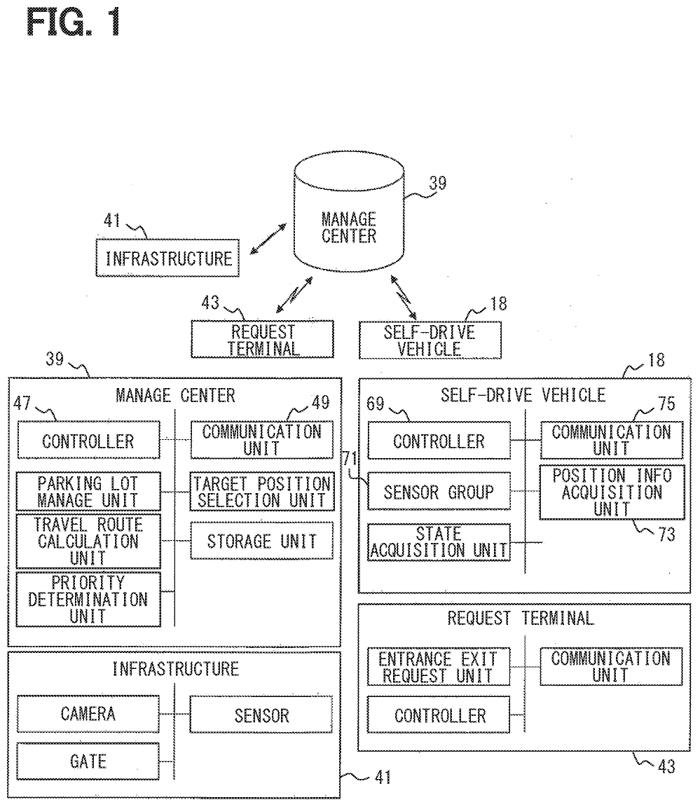

(1) As shown in FIG. 1, a management center (corresponding to a management device 39) is a server that manages parking of vehicles, and determines a traveling route to an empty parking space in a parking lot. The management center is configured to enable wireless communication with parking lot infrastructure, request terminals, and self-driving vehicles. The management center includes a computer (CPU) and a memory. The management center includes a controller, a parking lot management unit, a travel route calculation unit, a priority determination unit, a communication unit, a target position selection unit, and a storage unit. The memory stores map information of an inside area of the parking lot 3.

(2) Parking lot infrastructure is an infrastructure facility installed in the parking lot. The parking lot infrastructure includes cameras, sensors, gates and communication units.

(3) The self-driving vehicle is a vehicle that is able to perform automatic parking in the parking lot based on communication with the management center. The self-driving vehicle includes a computer (CPU) and a memory. The self-driving driving vehicle includes a controller, a sensor group, a state acquisition unit, a communication unit, and a position information acquisition unit.

(4) The request terminal is an operation terminal installed in the parking lot or a mobile terminal carried by a user. The request terminal transmits an entrance request and an exit request to the management center corresponding to an operation made by the user on the terminal. The request terminal includes a computer (CPU) and a memory. The request terminal includes a controller, an entrance/exit request unit, and a communication unit.

(Parking Lot Configuration)

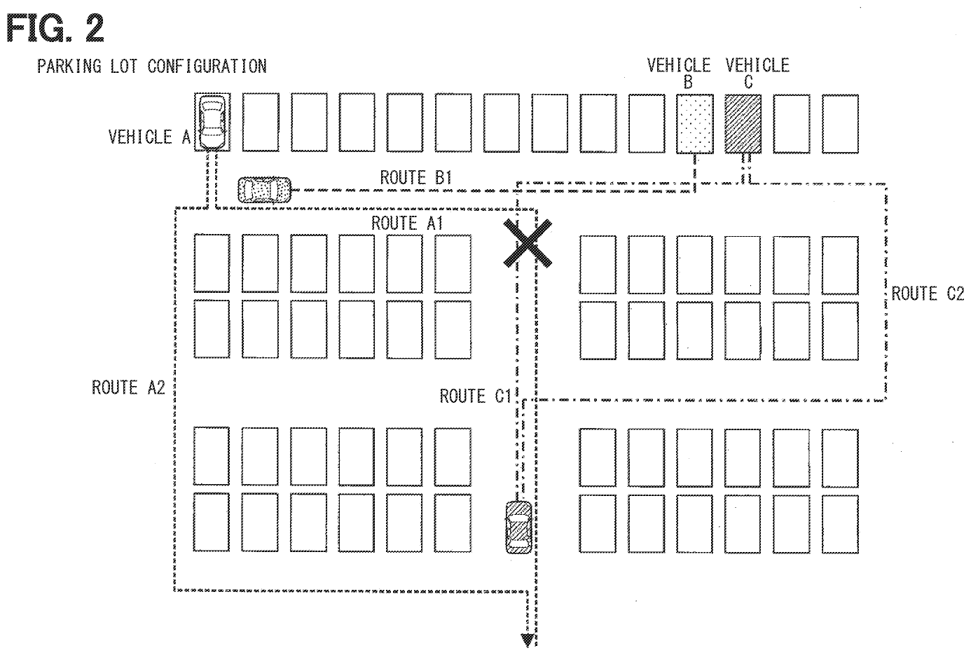

(1) As shown in FIG. 2, the vehicle A is a self-driving vehicle that moves from an entrance room to a target parking position through a route A1.

(2) The vehicle B is a self-driving vehicle that moves from a predetermined position, that is, a parking space in the parking lot to an exit room through a route B1.

(3) The vehicle C is a self-driving vehicle that moves from a predetermined position, that is, a parking space in the parking lot to an exit room through a route C1.

(4) The management center generates travel routes for vehicles A, B, and C and transmits the generated travel routes to respective vehicles. The management center generates a travel route so as not to overlap with a travel route of another self-driving vehicle, and transmits the generated travel route to the corresponding self-driving vehicle. For example, regarding the vehicle A, when the travel route A1 overlaps with other travel routes B1 and C1, the management center does not adopt the route A1, and generates another route A2 and transmits the another route A2 to the vehicle A. Regarding the vehicle C, when the travel route C1 overlaps with other travel routes A1 and B1, the management center does not adopt the route C1, and generates another route C2 and transmits the another route to the vehicle C.

(5) In order to generate a non-overlapping travel route, the management center reads a travel route of a different vehicle in the parking lot, and sets the travel route of different vehicle as an unavailable travel route. In this way, the management center narrows down a range of an available travel route of a subject vehicle based on a map in which the travel route of different vehicle is set to be unavailable. A quantity of the different vehicle may be one or more. A travel route of subject vehicle is generated within an available travel route based on a predetermined standard. When the travel route of subject vehicle cannot be generated within the available travel route, the vehicle waits for a predetermined time and generates the travel route again.

(Entrance/Exit Flow of Vehicle To/From Parking Lot)

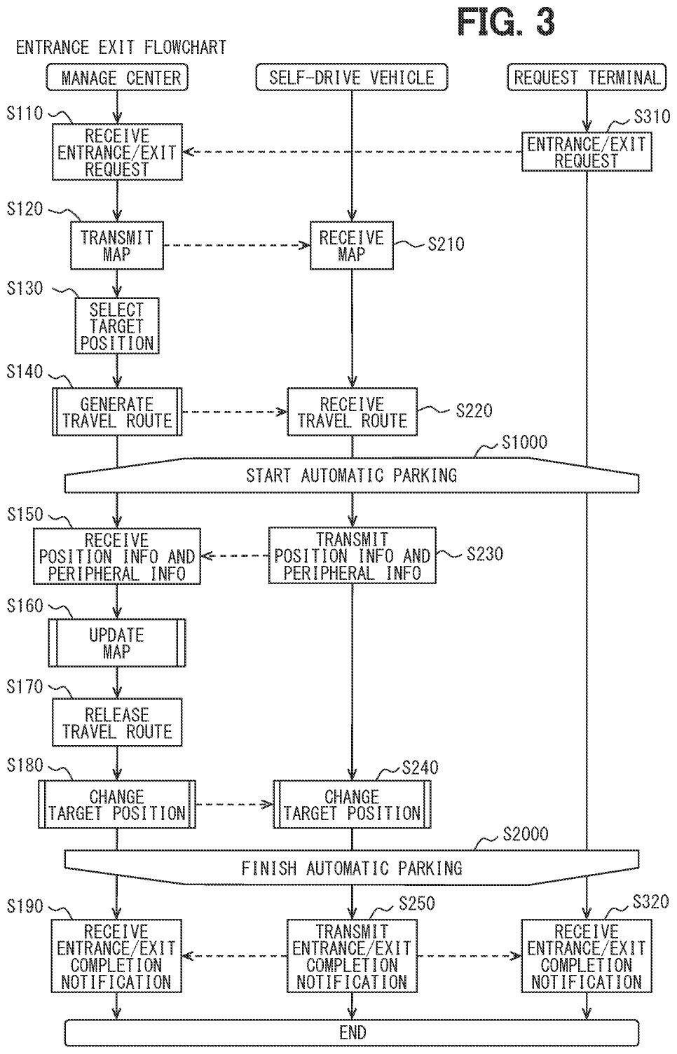

(1) As shown in FIG. 3, the request terminal transmits an entrance/exit request to the management center in S310. In response to a reception of the entrance/exit request from the request terminal in S110, the management center (manage control) transmits a map to the self-driving vehicle in S120. The self-driving vehicle receives and stores the map transmitted from the management center in S210. The management center selects a target position of the self-driving vehicle in S130.

The management center selects an empty parking space as the target position for the vehicle that requests an entrance into the parking lot. Hereinafter, the vehicle that requests an entrance into the parking lot is referred to as an entrance vehicle. The management center selects the exit room as the target position for the vehicle that requests an exit toward outside. Hereinafter, the vehicle that requests an exit toward outside is referred to as an exit vehicle. The management center performs a travel route generation process for generating a travel route (travel path) that guides to the target position in S140.

The management center generates a travel route to not overlap with the travel route of different vehicle. The management center transmits the generated travel route to the self-driving vehicle. The self-driving vehicle receives and stores the travel route transmitted from the management center. Then, the self-driving vehicle executes automatic valet parking while transmitting data such as the current position to the management center in S1000.

(2) The self-driving vehicle transmits position information and peripheral information of own vehicle to the management center during the automatic valet parking in S230. The management center performs an update process in S160 to update the map information based on the position information and the peripheral information received from the self-driving vehicle in S150. For example, the management center releases in S170 the travel route of different self-driving vehicle that has finished traveling along the set travel route. The management center changes, in S180, the target position and notifies the changed target position to the subject self-driving vehicle. Then, the self-driving vehicle executes automatic valet parking based on the changed target position.

(3) When the self-driving vehicle reaches the target position and the automatic valet parking is ended in S2000, the self-driving vehicle transmits an entrance/exit completion notification to both of the management center and the request terminal in S250. The management center receives the exit completion notification in S190, and the request terminal receives the exit completion notification in S320.

(Generation of Travel Route)

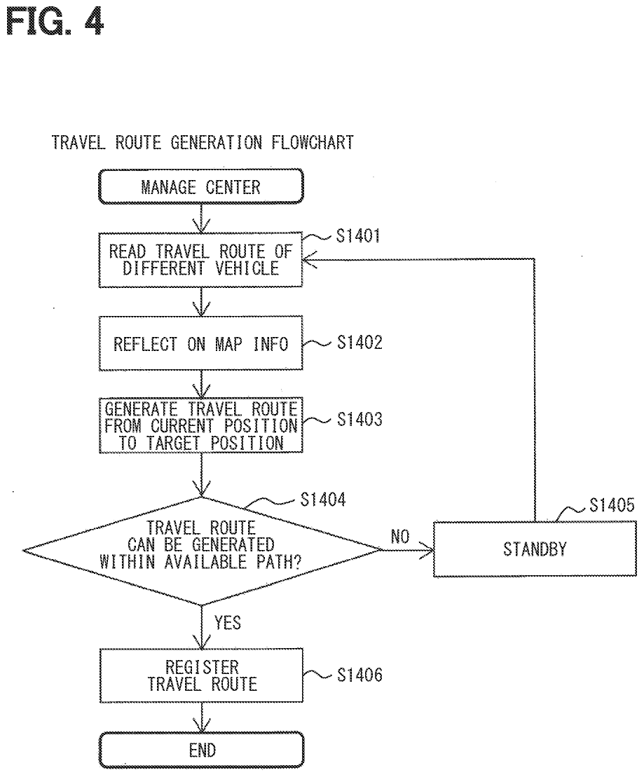

(1) As shown in FIG. 4, the management center (management control) reads the travel route of different vehicle which is executing the automatic valet parking in S1401. The management center reflects the travel route of different vehicle in the map information about available travel route so that the travel route of different vehicle is set as an unavailable travel route and remaining route is set as the available travel route in S1402. The management center generates the travel route of the subject vehicle from the current position of the self-driving vehicle to the target position in S1403.

The travel route of subject vehicle is generated so as to not overlap with the travel route of different vehicle. When the management center is able to generate a travel route to the target position using the available travel route in the map information (S1404: YES), the management center registers the generated travel route in S1406. When the management center fails to generate a travel route to the target position by using the available travel route in the map information (S1404: NO), the management center waits for a predetermined period and returns to S1401 (repeat reading of different vehicle's travel route).

### 2. Embodiments

The following will describe a detailed embodiment as an example of the present disclosure with reference to accompanying drawings.

(2-1. Configuration of parking assist system 1)

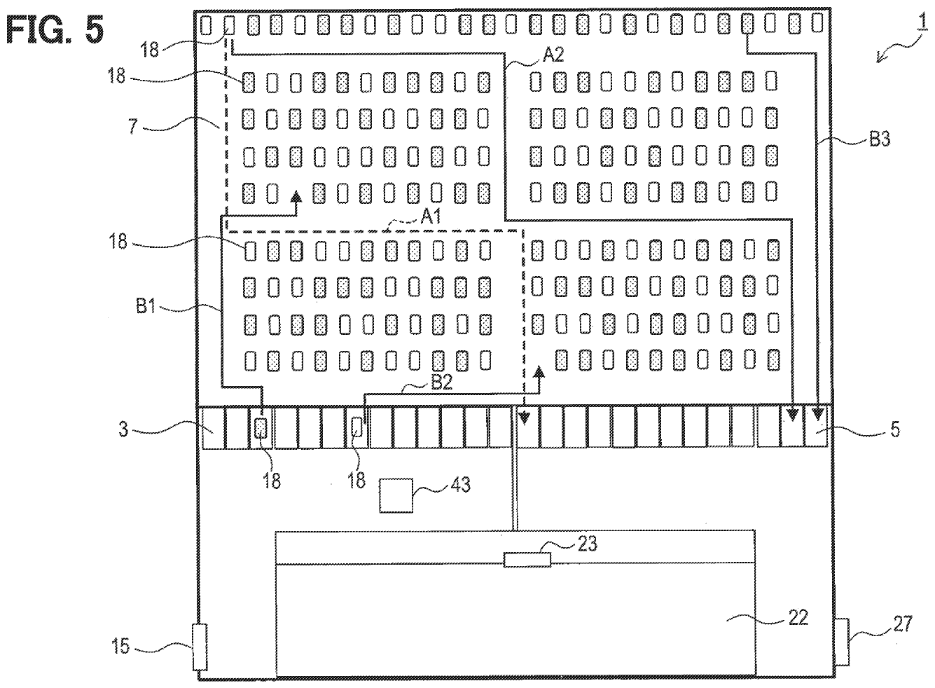

The following will describe a configuration of a parking assist system 1 with reference to FIG. 5 to FIG. 7. As shown in FIG. 5, the parking assist system 1 includes an entrance room 3 set in an alighting area where the user alights from the vehicle, and an exit room 5 set in a boarding area where the user boards on the vehicle, and a parking area 7. In the following description, an area including the entrance room 3, the exit room 5, and the parking area 7 is referred to as a parking lot.

In the parking lot, multiple entrance rooms 3 and multiple exit rooms 5 are prepared. The entrance room 3 is connected to an outside area of the parking assist system 1 through an entrance 15. The sell-driving vehicle 18 enters into the entrance room 3 of the parking lot through the entrance 15. The self-driving vehicle 18 has an automatic valet parking function.

It should be noted that the self-driving vehicle 18 only needs to be able to carry out the automatic valet parking function in the parking lot, and does not need to have a self-driving function outside the parking lot. Further, the automatic valet parking function includes a function of traveling from the entrance room 3 to the target parking position of the parking area 7 and parking by self-driving. The automatic valet parking function also includes a function of traveling from the parking position of the parking area 7 to the exit room 5.

The automatic valet parking function includes repeatedly acquiring the position information of the self-driving vehicle 18, transmitting acquired position information to the management device 39, receiving a guidance route from the management device 39, and controlling the self-driving vehicle 18 to travel along the received guidance route. The management device 39 corresponds to a parking assist apparatus of the present disclosure. The position information of the self-driving vehicle 18 indicates an estimation result of the current position of the self-driving vehicle 18, and includes, for example, coordinates of the current position within the area of the parking lot.

The entrance room 3 and the exit room 5 may be adjacent to an entrance 23 of a facility 22, such as a store. The occupant of the self-driving vehicle 18, who has entered the entrance room 3, gets off the self-driving vehicle 18. Then, the occupant can walk to the entrance 23.

The exit room 5 is connected to the outside area of the parking assist system 1 through an exit 27. The self-driving vehicle 18 can move from the exit room 5 to the outside of the parking assist system 1 through the exit 27. The exit room 5 is adjacent to the entrance 23 of the facility. The occupant can walk from the entrance 23 of facility to the exit room 5.

The parking area 7 is an area where multiple self-driving vehicles 18 can be parked. Multiple sections are provided inside the parking area 7. The parking area includes multiple paths through which the self-driving vehicle 18 can travel, and the multiple paths are set around the multiple sections in the parking lot 7. In the parking area 7, the multiple sections for parking vehicles are divided into multiple groups, and multiple sections are collectively arranged in each group. Multiple groups are arranged along the path. The parking area 7 has multiple intersections having T-shapes or cross shapes. The multiple paths are connected with one another at the intersections.

In the parking area 7 having such a configuration, at least two or more different guidance routes to the target position can be set. Further, each section of the entrance rooms 3, the exit rooms 5, and the parking area 7 is an area where one self-driving vehicle 18 can be parked.

The self-driving vehicle 18 can travel from the entrance room 3 to the parking area 7. The self-driving vehicle 18 can travel from the parking area 7 to the exit room 5.

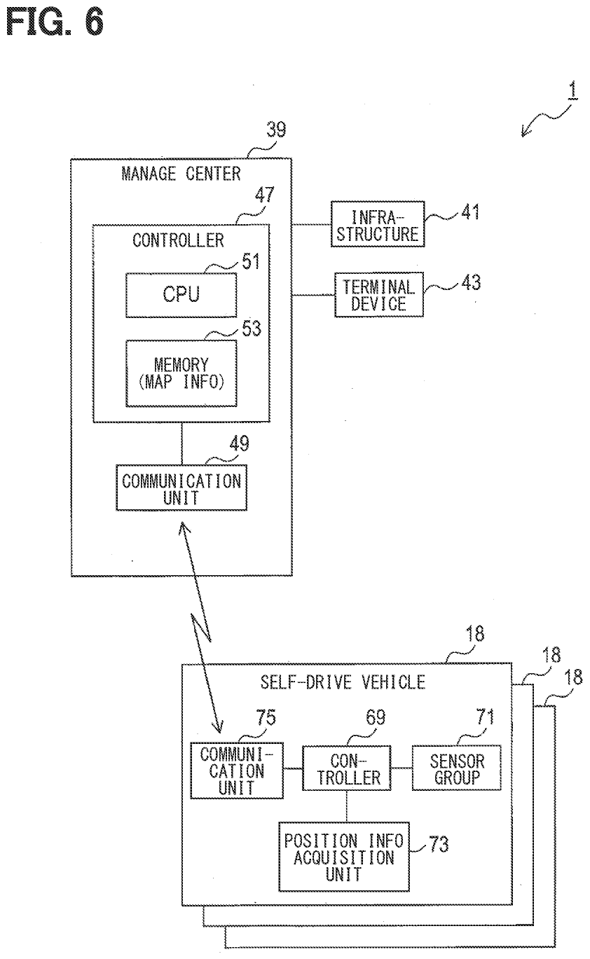

As illustrated in FIG. 6, the parking assist system 1 includes the management device 39, an infrastructure 41, and a terminal device 43.

The management device 39 includes a controller 47 and a communication unit 49. The controller 47 includes a microcomputer having a CPU 51 and a semiconductor memory (hereinafter referred to as a memory 53) such as a RAM or a ROM, for example.

The CPU 51 executes a program stored in a non-transitory tangible storage medium to perform functions to be provided by the controller 47. In this example, the memory 53 corresponds to a non-transitory tangible storage medium storing the program. When the program is executed, a method corresponding to the program is executed. The controller 47 may include one or more microcomputers.

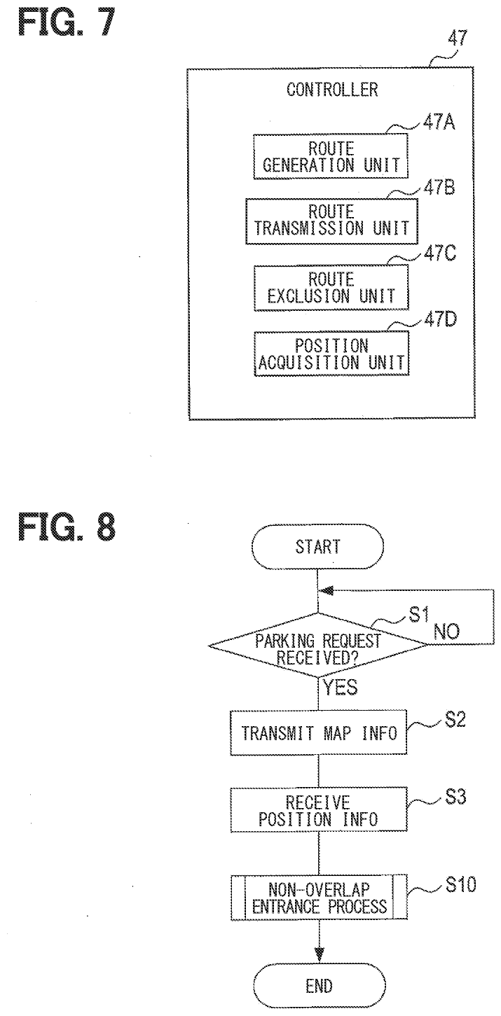

The controller 47 includes a configuration for transmitting, to the self-driving vehicle 18, a guidance route to the target position. As shown in FIG. 7, the controller 47 includes, for example, a route generation unit 47A, a route transmission unit 47B, a route exclusion unit 47C, and a position acquisition unit 47D. The following will describe an operation executed by each unit 47A to 47D included in the controller 47.

The memory 53 stores map information of the inside area of the parking lot. The map information includes information indicating a state of each parking space included in the parking are 7. The state of parking space may be an available state where the parking space is vacant (hereinafter referred to as a vacant state) and an unavailable state where the parking space is occupied by the self-driving vehicle 18 (hereinafter referred to as an occupied state). The communication unit 49 is configured to communicate with the self-driving vehicle 18.

The infrastructure 41 acquires information representing the state inside the parking assist system 1 (hereinafter referred to as parking lot information) and provides the parking lot information to the management device 39. The infrastructure 41 includes a camera, a LiDAR, or other devices that photograph the inside area of the parking assist system 1.

The parking lot information includes, for example, information indicating a position of an obstacle, information indicating a state of a parking space of the parking area 7, and position information of the self-driving vehicle 18 existing in the parking assist system 1.

As shown in FIG. 5, the terminal device 43 is installed close to the entrance room 3. The terminal device 43 accepts an input operation made by the user. The terminal device 43 outputs a signal indicating the input operation to the management device 39.

The terminal device 43 outputs a parking request signal in response to the input operation indicating, for example, a parking request. The parking request is a request from the user to enter the self-driving vehicle 18 into the parking area. The parking request signal is a signal that requests a transport of the self-driving vehicle 18 in the entrance room 3 to the parking area 7 and a parking of the self-driving vehicle 18 in the parking space. The terminal device 43 may output, to the management device 39, identification information of the self-driving vehicle 18 together with the signal output in response to the input operation.

The terminal device 43 outputs an exit request signal in response to the input operation indicating, for example, an exit request. The exit request is a request from the user to exit the self-driving vehicle 18 from the parking area. The exit request signal is a signal that requests a transport of the self-driving vehicle 18 parked in the parking area 7 to the exit room 5.

The terminal device 43 may output the identification information of the self-driving vehicle 18 in response to the input operation. The identification information may include number plate information for identifying the self-driving vehicle 18.

In a case, the terminal device 43 may receive an input operation indicating an exit request immediately after an output of the parking request signal before the self-driving vehicle 18 arrives at the parking area 7. In a case, the terminal device 43 may receive an input operation indicating an entrance request, that is, parking request immediately after an output of the exit request signal before the self-driving vehicle 18 arrives at the exit room 5.

As described above, the self-driving vehicle 18 has an automatic valet parking function. As shown in FIG. 6, each self-driving vehicle 18 includes a controller 69, a sensor group 71, a position information acquisition unit 73, and a communication unit 75. The controller 69 controls each portion of the self-driving vehicle 18. The function of the self-driving is performed by the controller 69. The self-driving vehicle 18 acquires, from the management device 39, the map information of the parking lot and the guidance route. When performing the self-driving, the self-driving vehicle 18 uses the acquired map information and the guidance route.

The sensor group 71 is configured to acquire peripheral information indicating a situation around the self-driving vehicle 18. The peripheral information includes, for example, a position of an obstacle existing around the self-driving vehicle 18. The sensor group 71 may include a camera, a LiDAR, and the like. The self-driving vehicle 18 uses the peripheral information when performing the self-driving.

The position information acquisition unit 73 acquires the position information of the self-driving vehicle 18. The position information acquisition unit 73 is, for example, a position estimation system using the LiDAR and a map. The self-driving vehicle 18 uses the position information when performing self-driving. The communication unit 75 is configured to communicate with the management device 39.

(2-2. Process)

(2-2-1. Parking Setting Process Executed by Management Device 39)

The following will describe the parking setting process executed by the management device 39 with reference to FIG. 8. The parking setting process may be configured to start in response to the power of the management device 39 being turned on. After start of the parking setting process, the process is repeatedly executed. The process after S2 may be executed for each self-driving vehicle 18 that has output the parking request.

In S1 of the parking setting process shown in FIG. 8, the route generation unit 47A of the management device 39 determines whether a parking request signal is received. When no parking request signal is received, the process repeats S1. When a parking request signal is received, the process proceeds to S2.

When a user such as an occupant of the self-driving vehicle 18 inputs a parking request by operating the terminal device 43, the terminal device 43 transmits a parking request signal corresponding to the user's input operation to the management device 39. At this time, the user inputs vehicle information such as number plate information for identifying the vehicle, user information such as a user ID and a password for identifying the user, and other necessary information to the terminal device 43.

When the terminal device 43 is operated, predetermined information such as the identification ID for identifying the terminal device 43, vehicle information, user information, and the like may be transmitted to the management device 39. After inputting the parking request, the user can leave the parking lot and head for a destination.

Subsequently, the route generation unit 47A transmits the map information of the parking lot to the self-driving vehicle 18 in S2. That is, when the user inputs, to the terminal device 43, the parking request, the route generation unit 47A transmits the map information of the parking lot to the self-driving vehicle 18.

The self-driving vehicle 18 that has received the map information is required to return the position information and the vehicle state. Thus, the route generation unit 47A can receive the position information transmitted from the self-driving vehicle 18 in S3.

The controller 47 performs a non-overlap entrance process in S10. The non-overlap entrance process generates, as a second guidance route, a guidance route of the subject vehicle to be not overlap with the guidance route of the different self-driving vehicle 18. The guidance route of the different self-driving vehicle corresponds to a first guidance route. Then, the non-overlap entrance process moves the self-driving vehicle 18 to the parking space along the second guidance route. When the non-overlap entrance process is completed, the management device 39 ends the parking setting process.

The term “non-overlap” in the present disclosure means multiple guidance routes do not intersect or contact with one another. The purpose of setting the guidance route is to avoid contact of one self-driving vehicle 18 with another self-driving vehicle 18. Thus, in a case where multiple guidance routes do not contact with one another, when there is a possibility that one self-driving vehicle 18 traveling along one guidance route contacts with another self-driving vehicle 18 traveling along another guidance route, the controller 47 determines that the multiple guidance routes contact with one another.

The guidance route is set by the parking setting process described above, and the guidance route is also set by an exit setting process described later in related manner with the guidance route generated by the parking setting process. In the parking setting process, the guidance route is set to avoid an overlap with the guidance route set in the exit setting process. Similarly, in the exit setting process, the guidance route is set to avoid an overlap with the guidance route set in the parking setting process.

(2-2-2. Non-Overlap Entrance Process)

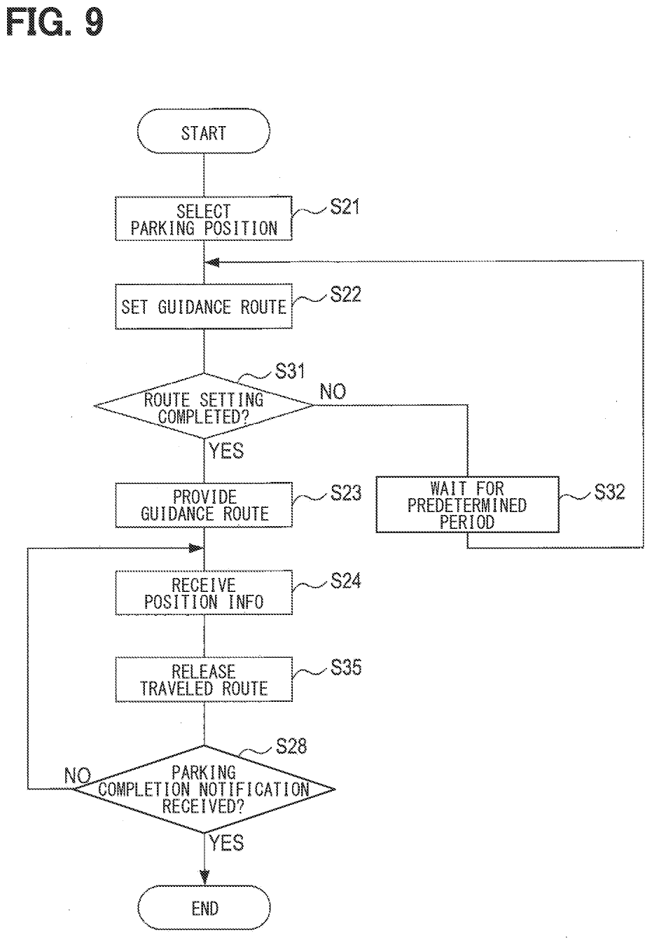

The following will describe the non-overlap entrance process executed by the management device 39 with reference to FIG. 9. In the non-overlap entrance process, in S21, the route generation unit 47A of the management device 39 selects the target position, that is, the parking position.

As the parking position, a parking space in the parking area 7, which is in the vacant state, may be selected. The route generation unit 47A determines the state of each parking space as follows, for example. When the self-driving vehicle 18 starts parking in a certain parking space, the self-driving vehicle 18 sends the identification information of the parking space and parking start information to the management device 39. Further, when the self-driving vehicle 18 leaves the parking space in which the vehicle has been parked, the self-vehicle 18 sends the identification information of the parking space and parking end information to the management device 39.

The route generation unit 47A determines the state of each parking space based on the history of information sent from the self-driving vehicle 18. Further, the route generation unit 47A may determine the state of each parking space based on the information supplied by the infrastructure 41.

When there is only one vacant parking space, the route generation unit 47A sets the vacant parking space as the parking position. When there are multiple vacant parking spaces, the route generation unit 47A selects one parking space as the parking position from the multiple vacant parking spaces based on predetermined criteria. Examples of the criteria include selecting the parking space closest to the entrance room 3, selecting the parking space closest to the exit room 5, and selecting the parking space in an area that includes relatively large number of vacant parking spaces.

In S22, the route generation unit 47A sets the guidance route using the map information of the parking lot. The guidance route is set before the self-driving vehicle 18 starts the self-driving to the parking position, that is, while the self-driving vehicle 18 is in a stopped state. Here, the route generation unit 47A sets a route from the current position of the self-driving vehicle 18 to the parking position selected in S21. The route set by the route generation unit is a guidance route for the self-driving vehicle 18 to perform the self-driving.

When the guidance route for different self-driving vehicle 18 already exists, the route generation unit 47A generates the guidance route of the subject self-driving vehicle 18 to avoid the guidance route of different self-driving vehicle. That is, the guidance route of the subject self-driving vehicle is set to avoid an overlap with the guidance route of different self-driving vehicle 18.

For example, as shown in FIG. 5, when trying to set the guidance route A1 under a state that the guidance routes B1 and B2 are set previously, the guidance route intersects with previously set guidance routes B1, B2 cannot be set. In this case, in order to avoid the guidance routes B1 and B2, for example, a guidance route A2 is set and guidance of the vehicle along the set guidance route A2 is started. The guidance route A2 is set so as not to overlap with the guidance route B3.

The map information of the parking lot stored in the memory 53 is associated with information indicating availability of each path in the parking lot as a guidance route. When a path includes multiple traveling lanes, the map information may be associated with information indicating availability of each traveling lane of the path as a guidance route.

Then, the path set as the guidance route is set to be unavailable. When the self-driving vehicle 18 completes traveling along the guidance route and the guidance route is released, the path can be set to be available again. All of the paths in the parking lot are set to be available or unavailable for each section (for example, for each link described later) by the controller 47.

In S22, when the guidance route to be set (for example, the guidance route having the shortest distance, the guidance route set in bypass manner) overlaps with the guidance route of different self-driving vehicle 18, the setting of guidance route ends with failure. There may exist multiple guidance routes to the target position. However, there is a possibility that all of the existing multiple guidance routes overlap with the guidance route of different self-driving vehicle 18. Thus, in S22, the generation of guidance route may end with failure. Thus, the route generation unit 47A determines in S31 whether the guidance route of the subject self-driving vehicle 18 is set.

In response to the failure if guidance route setting, in S32, the route generation unit 47A waits for a predetermined time set in advance, then returns to S22 and tries to set the guidance route again. The guidance route may be reset immediately. In the present embodiment, in order to reduce the processing load of the management device 39, the guidance route is reset after waiting for a predetermined time.

In the present embodiment, in S35 described later, immediately after the different self-driving vehicle 18 completes the traveling along its guidance route, the guidance route of different self-driving vehicle 18 is released. Therefore, when the route generation unit 47A resets the guidance route after waiting for a predetermined time, a success possibility of the guidance route setting can increases, and it is possible to suppress the repetition of unnecessary processing in which guidance route setting ends with failure.

When the guidance route is set, the route transmission unit 47B transmits, in S23, information representing the guidance route set in S22 (hereinafter referred to as guidance route information) using the communication unit 49. As being described later, the self-driving vehicle 18 receives the guidance route information, and starts self-driving along the set guidance route.

The position acquisition unit 47D of the management device 39 acquires, in S24, the position information of the self-driving vehicle 18 in S24. That is, the position acquisition unit 47D repeatedly receives the position information of each self-driving vehicles 18 in the parking lot until a parking completion notification of the subject self-driving vehicle 18 is received.

In S35, when the self-driving vehicle 18 completes the traveling along the set guidance route, the route exclusion unit 47C releases the guidance route. That is, the route exclusion unit 47C identifies, among all of the paths in the parking lot, partial portion of the guidance route, which has been traveled by the self-driving vehicle 18, based on the current position of the self-driving vehicle 18, and excludes the identified portion from the guidance route. More specifically, for the identified portion of the path in the parking lot, the route exclusion unit 47C changes the setting, in the map information, from the unavailable state to the available state. The identified portion of the path is the portion that has been traveled by the self-driving vehicle 18. As a result, the portion, which the self-driving vehicle 18 has already traveled, can be used as a guidance route for a subsequent self-driving vehicle 18.

The route generation unit 47A determines in S28 whether the communication unit 49 has received the parking completion notification. The parking completion notification is a notification transmitted by the self-driving vehicle 18 when the self-driving vehicle 18 completes parking at the target position, which is the end point of the guidance route. The target position also corresponds to the parking position. In response to reception of the parking completion notification, the process is ended. In response to no reception of the parking completion notification, the process returns to S24.

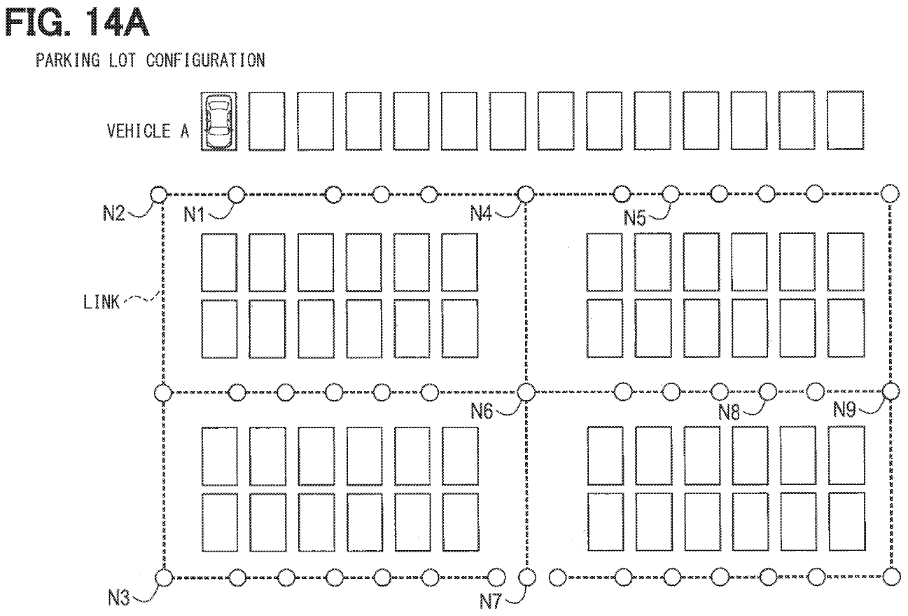

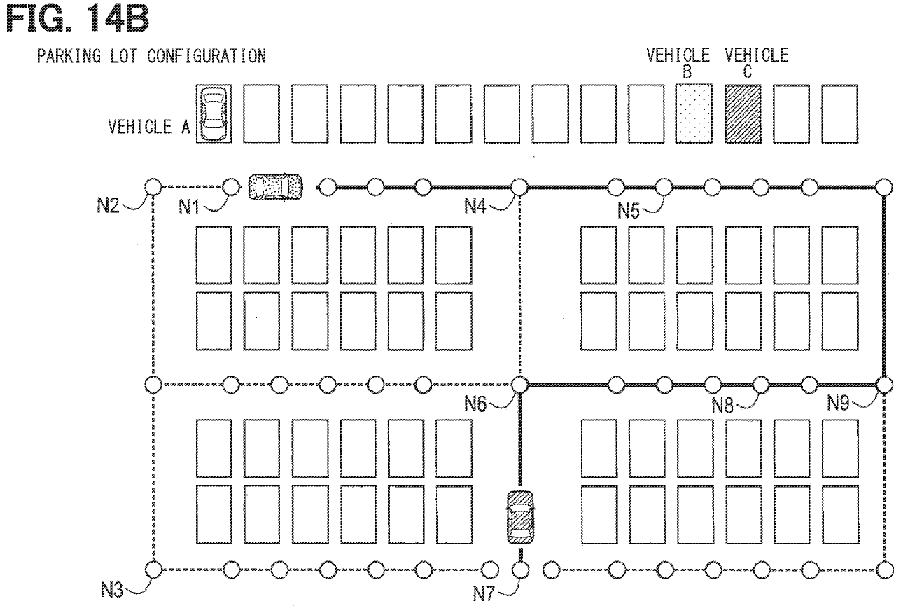

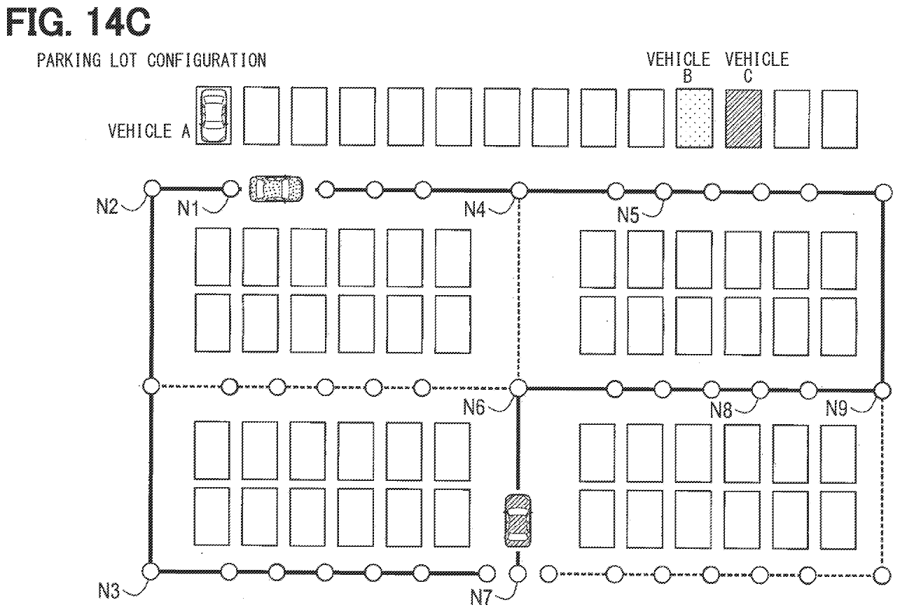

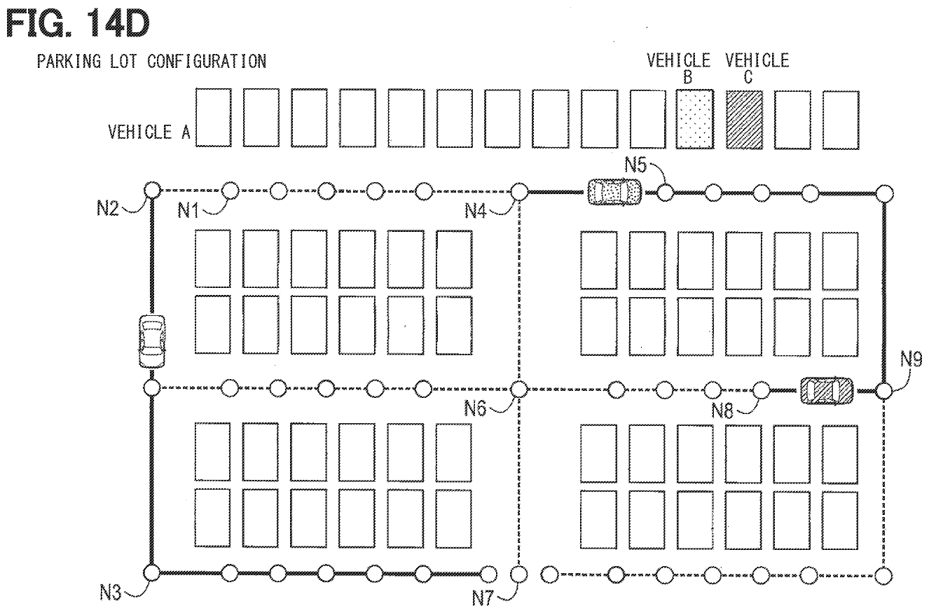

The route generation unit 47A performs the setting of the available or unavailable path in the parking lot, the setting of the guidance route, and the release of the traveled route, and these process will be described with reference to FIG. 14A to FIG. 14D. FIG. 14A to FIG. 14D conceptually show whether a path in the parking lot is available. Each path in the parking lot consists of nodes and links. In FIG. 14A to FIG. 14D, nodes N1 to N9 are described as examples for convenience.

In FIG. 14A to FIG. 14D, the vehicle A is a self-driving vehicle 18 that moves from the entrance room 3 to the target parking position. The vehicle B is a self-driving vehicle 18 that moves from a predetermined position in the parking area to the exit room 5. The vehicle C is a self-driving vehicle 18 that moves from a predetermined position in the parking area to the exit room 5.

The map information of the parking lot stored in the memory 53 is associated with information indicating availability of each path in the parking lot as the guidance route. The memory 53 stores information (also referred to as a flag) indicating whether the path (also referred to as a link) between adjacent two nodes can be used as a guidance route. In FIG. 14A to FIG. 14D, when the path between adjacent two nodes is set to be available, the path is indicated by a dotted line, and when the path between two adjacent nodes is set to be unavailable, the path is indicated by a solid line. The memory 53 further stores the vehicle A, B, C in association with corresponding guidance route.

In FIG. 14A, no guidance route is set, so all paths are available. In FIG. 14B, the vehicle B and the vehicle C entered the parking lot prior to the vehicle A. FIG. 14B shows a state where the vehicle A is in the entrance room, and the guidance route of the vehicle A is not yet set. The guidance routes of the vehicle B and the vehicle C have been set so as not to overlap with one another. As shown in FIG. 2, the guidance route of the vehicle B is the guidance route B1, and the guidance route of the vehicle C is the guidance route C2. Thus, in FIG. 14B, the path including the node N1 to the nodes N4 and N5 is set to be unavailable. The path including the node N7 to the nodes N8 and N9 is set to be unavailable.

In S22, when the route generation unit 47A sets the guidance route of the vehicle A, the route generation unit 47A connects only the available paths, that is, only the paths indicated by the dotted lines in FIG. 14B, to arrive at the target position. For example, in FIG. 14B, a guidance route including nodes N2 and N3, that is, a guidance route A2 shown in FIG. 2 is set. In this case, as shown in FIG. 14C, the route generation unit 47A sets the path included in the guidance route A2 to be unavailable.

In S35, the route exclusion unit 47C releases the traveled route. The release of the traveled route will be described with reference to FIG. 14D.

In FIG. 14D, the vehicle A, the vehicle B, and the vehicle C perform self-driving along the respective guidance routes A2, B1, C2 set by the route generation unit 47A. Each vehicle periodically and repeatedly transmits the position information to the management device 39 until completion of the parking at the target position. Therefore, for each guidance route, the management device 39 can specify partial portion of the guidance route in which the vehicle has already traveled based on the guidance route set for the corresponding vehicle and the current position of the corresponding vehicle. For example, the management device may compare current position of the vehicle with the nodes of path, and determines that the vehicle has passed the node based on the comparison result. For the traveled path (for example, the traveled link and node), the state is changed to be available.

For each vehicle, the route exclusion unit 47C identifies the path that the vehicle has already traveled, and changes, in the map information of the memory 53, the setting of the path (partial portion of the path) from the unavailable state to the available state.

In FIG. 14D, the vehicle B is located between the node N4 and the node N5, and the path from the node N1 to the node N4, which has been traveled by the vehicle B is changed to be available. The vehicle C is located between the node N8 and the node N9, and the path from the node N7 to the node N8, which has been traveled by the vehicle C, is changed to be available. The path between the node N1 and the node N2 was set to be unavailable when the vehicle A started traveling from the entrance room. After the vehicle A leaves the entrance room as shown in FIG. 14D, the path between the node N1 and N2 is set to be available.

In S31, the management device determines whether the guidance route of the self-driving vehicle 18 is set. When the guidance route generation unit 47A fails to set the guidance route, the guidance route generation unit waits for a predetermined time in S32. During the standby time, the route exclusion unit 47C releases the traveled route. Information on whether each path in the parking lot is available continues to be updated in accordance with the traveling of the vehicles within the parking lot. Therefore, when the route generation unit 47A tries to set the guidance route for the self-driving vehicle 18 again after the predetermined time, it is highly possible to set the guidance route that does not overlap with another guidance route.

When the traveled route is released in S35, the route exclusion unit 47C may transmit, to the route generation unit 47A, a signal indicating that the path is change from the unavailable state to the available state. The route generation unit 47A may be configured to execute the reset of the guidance route (S22) for the vehicle that stands by in S32, in response to the release of the traveled route by the route exclusion unit. According to this configuration, the waiting time of the vehicle can be further shortened.

In FIG. 14A to FIG. 14D, it is assumed that a node and a link are set corresponding to each parking space. The method of indicating availability of each path as the guidance route is not limited to the above-described configuration. Alternatively, the parking area may be divided into multiple sections, and an availability of each section, that is, the section includes a vacant parking space may be set for each section as another example. The path may be divided into multiple section at a predetermined distance, and the availability may be set for each segment.

(2-2-3. Automatic Parking Process Executed by Self-Driving Vehicle 18)

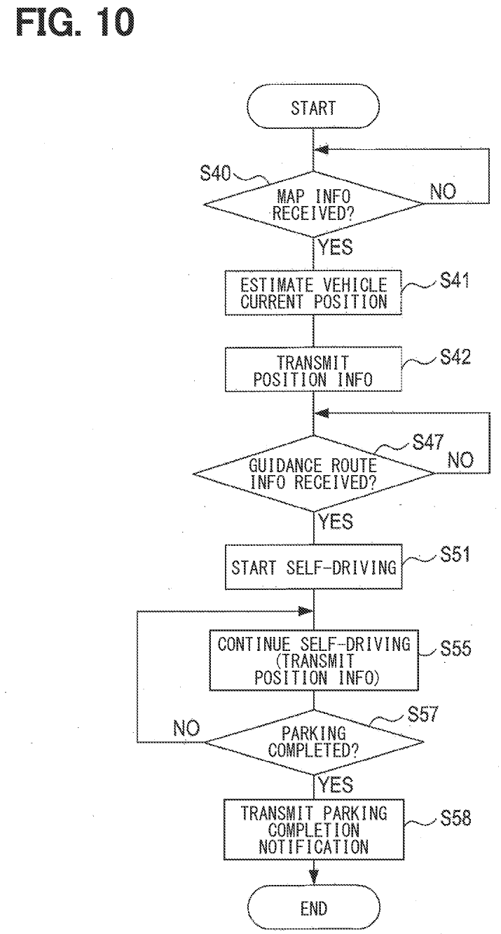

The following will describe an automatic parking process executed by the self-driving vehicle 18 with reference to FIG. 10. The automatic parking process is a process in which the self-driving vehicle 18 automatically moves from the entrance room 3 to the parking position according to the parking setting process executed by the management device 39.

The controller 69 of the self-driving vehicle 18 determines, in S40, whether the communication unit 75 has received the map information of the parking lot. When the map information is not received, the process repeats S40.

When the map information is received, the process proceeds to S41, and the controller 69 estimates, in S41, the current position of the self-driving vehicle 18. Then, in S42, the controller 69 transmits the estimation result of the current position to the management device 39 as the position information of the self-driving vehicle 18.

The controller 69 determines, in S47, whether guidance route information is received. When determining the guidance route information is not received in S47, the process repeats S47.

When the guidance route information is received in S47, the controller 69 starts the self-driving of the self-driving vehicle 18 in S51. When performing the self-driving, the controller 69 drives the self-driving vehicle 18 according to the guidance route indicated by the guidance route information.

The controller 69 continues the self-driving of the self-driving vehicle 18 in S55. At this time, the controller 69 repeatedly transmits the position information of the self-driving vehicle 18 to the management device 39 until the parking of the self-driving vehicle is determined to be completed in S57. The management device 39 receives the position information transmitted by the controller 69 of the self-driving vehicle.

The controller 69 determines, in S57, whether the parking is completed. The completion of parking is determined when the self-driving vehicle 18 arrives at the parking position and is properly parked in the parking position set by the management device 39. When the parking is yet not completed, the process return to S55.

In S57, when determining that the parking is completed, the process proceeds to S58, and the controller 69 transmits the parking completion notification using the communication unit 75. Then, the process is ended. The management device 39 receives the parking completion notification transmitted from the self-driving vehicle.

(2-2-4. Exit Setting Process Executed by Management Device 39)

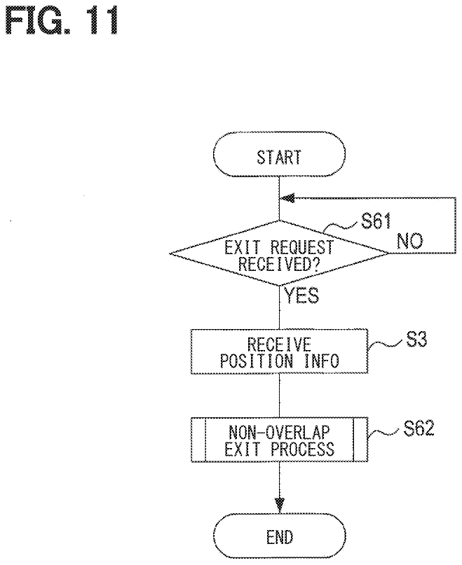

The following will describe an exit setting process executed by the management device 39 with reference to FIG. 11. The exit setting process is a process for moving the self-driving vehicle 18 from the parking position to the exit room 5 using the self-driving function of the self-driving vehicle 18. The process after S3 may be executed for each self-driving vehicle 18 that has output the exit request.

The exit setting process is a process that the controller 47 of the management device 39 repeatedly executes, for example, in parallel with other processes. When the exit setting process starts, in S61, the route generation unit 47A determines whether the exit request signal is received. Here, the exit request signal is a signal indicating a request to move the self-driving vehicle 18 from the parking position to the exit room 5. When the user operates the terminal device 43 to input the exit request, the terminal device 43 A transmits the exit request signal to the management device 39.

When no exit request signal is received, the process repeats S61. When the exit request signal is received in S61, the process transmits proceeds to S3. In S3, the management device receive the position information transmitted from the self-driving vehicle 18. Then, the process proceeds to S62, and executes a non-overlap exit process in S62. The non-overlap exit process is a process of generating a guidance route of the subject self-driving vehicle to not overlap with the guidance route of different self-driving vehicle 18 and moving the subject self-driving vehicle 18 to the exit room 5 along the set guidance route. When the non-overlap exit process is completed, the management device 39 ends the exit setting process.

(2-2-5. Non-Overlap Exit Process)

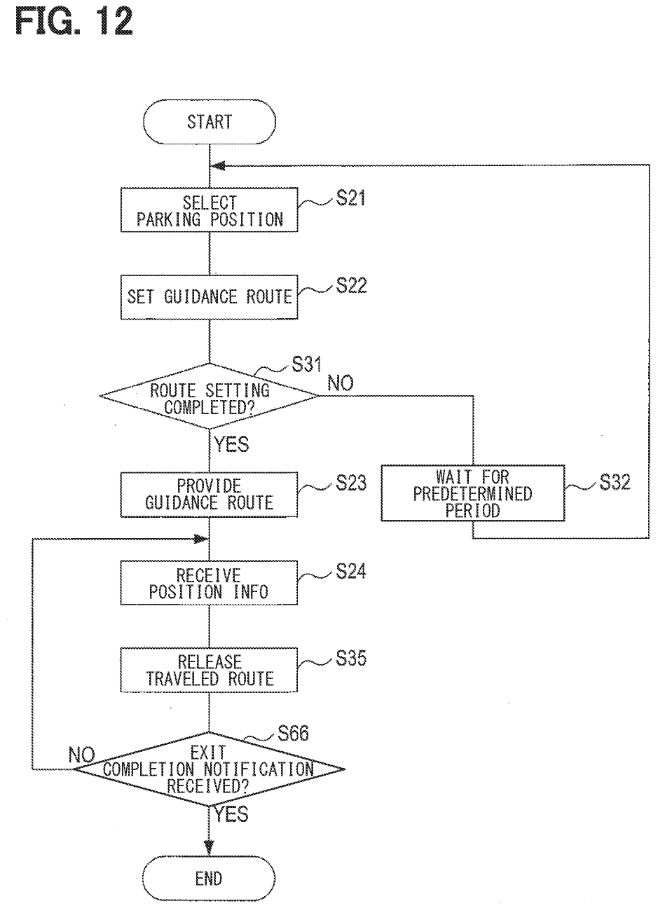

The following will describe a non-overlap exit setting process executed by the management device 39 with reference to FIG. 12. In the non-overlap exit process, as shown in FIG. 12, the management device executes S21 to S24, S31 and S32, and S35 similar to the above-described non-overlap entrance process shown in FIG. 9. Different from the non-overlap entrance process, in S21 of non-overlap exit process, the route generation unit 47A selects an exit room 5 as the target position of the guidance route. In the setting of the guidance route in S22, the guidance route is set before the self-driving vehicle 18 starts the self-driving to the exit room 5, that is, while the self-driving vehicle 18 is in a stopped state.

After S35, the route generation unit 47A determines in S66 whether the communication unit 49 has received an exit completion notification. The exit completion notification is a notification transmitted from the self-driving vehicle 18 when the self-driving vehicle 18 arrives at the exit room 5 which is the target position of the self-driving.

When the route generation unit 47A has not received the exit completion notification, the process returns S24. When the route generation unit 47A receives the exit completion notification, the process is ended.

(2-2-6. Automatic Exit Process Executed by Self-Driving Vehicle 18)

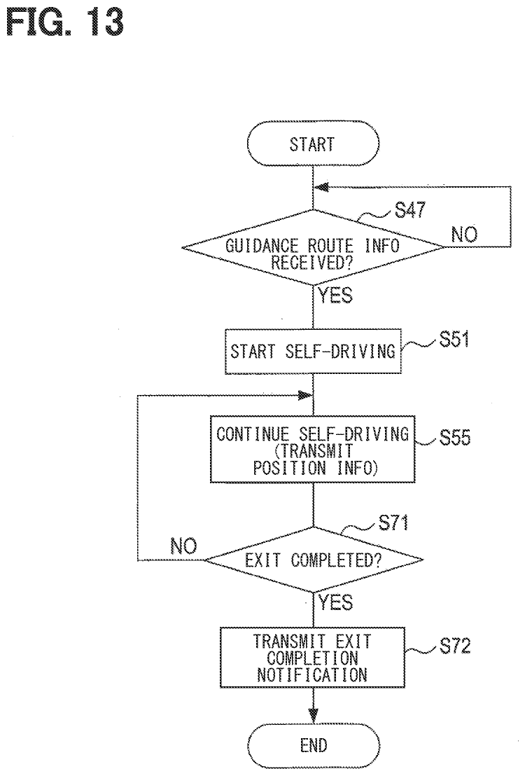

The following will describe an automatic exit process executed by the self-driving vehicle 18 with reference to FIG. 13. The automatic exit process is a process for moving the self-driving vehicle 18 from the parking position to the exit room 5 according to the exit setting process executed by the management device 39.

In the automatic exit process, as shown in FIG. 13, the processes in S47, S51, and S55 are executed similar to the above-described automatic parking process. After S55, the controller 69 determines in S71 whether the exit of self-driving vehicle is completed. When determining that the self-driving vehicle 18 arrives at the exit room 5, which is the target position, the controller 69 determines that the exit is completed.

When determining that the exit is not yet completed, the process returns to S55. When the exit is determined to be completed in S71, the controller 69 sends the exit completion notification to the management device 39 in S72, and ends the automatic exit process.

(2-3. Technical Effects)

The above-described embodiment provides the following effects.

(2a) One aspect of the present disclosure provides the management device 39 configured to assist parking of the self-driving vehicle in the parking lot. In the parking lot, multiple vehicles, which can perform self-driving according to respective guidance routes generated by the management device 39, are referred to as self-driving vehicles 18. The management device 39 includes the route generation unit 47A and the route transmission unit 47B.

The route generation unit 47A is configured to generate the guidance route for each of the multiple self-driving vehicles 18 so as not to overlap with the guidance route of different self-driving vehicles 18. When the guidance route is generated, the route transmission unit 47B is configured to transmit the generated guidance route to the corresponding self-driving vehicle 18. Then, the self-driving vehicle performs self driving along the generated guidance route.

According to this configuration, the guidance route is generated to not overlap with the guidance route of different self-driving vehicle 18. Thus, the self-driving vehicle 18 can be guided with improved safety. Before the self-driving vehicle 18 starts the self-driving, the guidance route that does not overlap with guidance route of different self-driving vehicles 18 is set. Thus, in a case where the management device fails to obtain accurate position information of the self-driving vehicles due to communication delay or the like during execution of the self-driving, it is possible to guide the multiple self-driving vehicles 18 with improved safely.

(2b) According to one aspect of the present disclosure, the route generation unit 47A sets the guidance route of the self-driving vehicle 18 which newly requests the driving assist as the second guidance route. In this case, the already generated guidance route set for the self-driving vehicle 18 traveling in the parking lot is referred to as the first guidance route. The route generation unit sets the second guidance route to not overlap with the first guidance route.

With this configuration, when the first guidance route, which is the guidance route of different self-driving vehicle 18, already exists, the second guidance route can be generated to avoid an overlap with the first guidance route.

(2c) According to one aspect of the present disclosure, the route exclusion unit 47C is configured to exclude the first guidance route for which the different self-driving vehicle 18 has completed traveling from the first guidance route. That is, the path set as the first guidance route and thus unavailable by other vehicles is reset to the available state. When the route generation unit fails to generate the second guidance route, the route generation unit 47A generates the second guidance route again after an elapse of predetermined time.

With this configuration, when the route generation unit fails to generate the second guidance route, after waiting until at least a portion of the first guidance route is excluded from the first guidance route, the route generation unit can try again to generate the second guidance route. Thus, even when the generation of second guidance route fails in first time, the second guidance route becomes to be generated easily after waiting a predetermined time.

(2d) According to one aspect of the present disclosure, the position acquisition unit 47D is configured to periodically receive the position information of the multiple self-driving vehicles 18 at a predetermined interval. The route exclusion unit 47C is configured to identify a portion of the first guidance route for which different self-driving vehicle 18 has finished traveling based on the position information of different self-driving vehicle, and exclude the traveled portion from the first guidance route.

With this configuration, until one self-driving vehicle 18 completes traveling along the first guidance route, partial portion of the first guidance route in which the one self-driving vehicle 18 has finished the traveling can be used by another self-driving vehicle 18. Thus, the second guidance route for another self-driving vehicle 18 can be easily generated by using the traveled portion of the first guidance route in a case where the generation of second guidance route fails in the first time. That is, available paths in the parking lot which can be set as the second guidance route of another self-driving vehicle is increased by setting, in real-time manner, the traveled potion of the first guidance route from unavailable state to available state.

(2e) According to one aspect of the present disclosure, the route generation unit 47A sets the path of the first guidance route to unavailable in the map information. The map information includes positions of paths included in the parking lot. Thus, the guidance route is generated to not include the path that is set to be unavailable.

According to this configuration, the second guidance route may be specifically set using the map information. Further, by this generation method, it is not necessary to determine whether multiple guidance routes overlap with one another. Therefore, it is not necessary to reset the guidance route that is required in a case where multiple guidance routes overlap with one another. Thus, the number of times that the management device 39 generates the guidance route of the self-driving vehicle 18 can be reduced, and the processing load of the controller can be reduced accordingly.

(2f) According to one aspect of the present disclosure, before the self-driving vehicle 18 moves from the parking area to the boarding area by the self-driving, the route generation unit 47A generates the guidance route to not overlap with the guidance route of different self-driving vehicle 18, and transmits the generated guidance route to the self-driving vehicle 18.

With this configuration, since the guidance route is transmitted to the self-driving vehicle 18 before the self-driving vehicle 18 starts the self-driving, the guidance route can be safely and reliably transmitted to the self-driving vehicle 18.

(2g) The multiple self-driving vehicles 18 include a first vehicle (for example, the self-driving vehicle 18 for which the guidance route B1 is set as shown in FIG. 5) and a second vehicle (for example, the self-driving vehicle 18 for which the guidance route A2 is set as shown in FIG. 5). When the second vehicle requests parking assistance after the guidance route for the first vehicle is generated, the route generation unit 47A generates the guidance route of the second vehicle to not overlap with the guidance route of the first vehicle without changing the guidance route of the first vehicle.

According to this configuration, the self-driving of the second vehicle can be executed without affecting the self-driving of the first vehicle.

### 3. Other Embodiments

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

(3a) In the above embodiment, entrance and exit of the self-driving vehicle is described. The present disclosure is not limited to this configuration. For example, the above configuration may also be applied to a situation where the self-driving vehicle 18 moves from the current parking position to another parking position in the parking lot. Specifically, in S61 of exit setting process shown in FIG. 12, the management device 39 may execute S3 and the following process in response to a reception of a movement request signal in addition to a reception of the exit request signal.

The management device 39 generates the movement request signal for a vehicle other than the vehicle that intends to enter or exit the parking lot in a case where the parking request signal or the exit request signal is received and the entrance or exit of the request source vehicle cannot be executed without moving the parked vehicle in the parking lot to another parking position.

(3b) In the above embodiment, the route generation unit 47A generates the subsequent guidance route, which is set at a later time, to avoid the prior guidance route, which is set at an earlier time. Specifically, the route generation unit 47A generates the subsequent guidance route, which is set at a later time, to not overlap with the prior guidance route, which is set at an earlier time. As another example, the subsequent guidance route may be generated by allowing an overlap with the prior guidance route, and then the prior guidance route that was set earlier is changed to not overlap with the guidance route that is set later.

In this case, for example, as shown in FIG. 5, after A1 is set as the guidance route of the self-driving vehicle 18, which has an abnormality, the guidance routes B1, B2 are set for other self-driving vehicles 18. In this case, the guidance route A1 may be changed to a different guidance route A2 to avoid overlap with the guidance routes B1, B2 of other self-driving vehicles. This change is made to avoid overlap of guidance route A1 with the guidance routes B1 and B2. At this time, the guidance route A2 is set to avoid an overlap with the guidance route B3.

(3c) In the above embodiment, the guidance routes of the self-driving vehicles 18 are successively set in order in response to the requests, such as parking request or exit request. The present disclosure is not limited to this configuration. For example, when receiving a request from one self-driving vehicle 18, the management device may generate the guidance route in response to the request. In this case, the management device may generate a guidance route of another vehicle that does not affect the request source vehicle concurrently with the generation of the guidance route of the request source vehicle. This configuration provides an effective solution when changing the set guidance route or the like.

(3d) In the above embodiment, the route exclusion unit 47C sets the portion of the guidance route in which the self-driving vehicle 18 has finished traveling to available state. The present disclosure is not limited to this configuration. For example, when the travel of the entire portion of guidance route is completed, the entire portion of guidance route which the self-driving vehicle 18 has completed traveling may be excluded from the guidance route and set to be available with the whole guidance route as one unit. Specifically, when the route exclusion unit 47C receives the parking completion notification or the exit completion notification, the route exclusion unit 47C may delete the guidance route in response to the notification.

(3e) The multiple functions of one component in the above embodiments may be implemented by multiple components, or a function of one component may be implemented by multiple components. Further, multiple functions of multiple components may be implemented by one component, or one function implemented by multiple components may be implemented by one component. A part of the configuration of the above-described embodiment may be omitted. Further, at least part of the configuration of the above-described embodiment may be added to or replaced with the configuration of another embodiment described above.

(3f) In addition to the parking assist system 1 described above, the present disclosure may be implemented in various forms, such as the management device 39 as a component of the parking assist system 1, a program to implement a computer as that management device 39, a non-transitory tangible storage medium such as a semiconductor memory storing the program, and a parking assist method.

The above-described controller and the techniques thereof according to the present disclosure may be implemented by one or more special-purposed computers. Such a special-purposed computer may be provided (i) by configuring (a) a processor and a memory programmed to execute one or more functions embodied by a computer program, or (ii) by configuring (b) a processor including one or more dedicated hardware logic circuits, or (iii) by configuring by a combination of (a) a processor and a memory programmed to execute one or more functions embodied by a computer program and (b) a processor including one or more dedicated hardware logic circuits. Further, the computer program may be stored in a computer-readable non-transitory tangible storage medium as instructions to be executed by a computer. The technique for realizing the functions of controller does not necessarily need to include software, and all the functions may be realized using one or a plurality of hardware circuits.

What is claimed is:

1. A parking assist apparatus assisting a vehicle parking, the parking assist apparatus comprising:
a route generation unit generating a guidance route for each of a plurality of self-driving vehicles existing in a parking lot, the guidance routes of the plurality of self-driving vehicles being generated to not overlap with one another, each of the plurality of self-driving vehicles being capable of executing a self-driving along the corresponding guidance route; and
a route transmission unit transmitting the guidance route to the corresponding self-driving vehicle, which plans to travel along the guidance route, when the guidance route is generated for the corresponding self-driving vehicle,
wherein,
when the guidance route of one of the plurality of self-driving vehicles to be generated overlaps with the guidance route of another one of the plurality of self-driving vehicles that has been generated, the route generation unit cancels a generation of the guidance route for the one of the plurality of self-driving vehicles.

2. The parking assist apparatus according to claim 1, wherein,
when the route generation unit cancels the generation of the guidance route for the one of the plurality of self-driving vehicles, the route generation unit generates the guidance route for the one of the plurality of self-driving vehicles again after an elapse of a predetermined period.

3. The parking assist apparatus according to claim 1, wherein
each of the guidance routes that has been generated for the corresponding self-driving vehicle is referred to as a first guidance route, and
the route generation unit generates, for a self-driving vehicle that newly requests a parking assist, a second guidance route to no not overlap with the first guidance route.

4. The parking assist apparatus according to claim 3, further comprising
a route exclusion unit deactivating a setting of the first guidance route after the corresponding self-driving vehicle completes a traveling along the first guidance route,
wherein,
when the route generation unit fails to generate the second guidance route to not overlap with the first guidance route, the route generation unit tries to generate the second guidance route again.

5. The parking assist apparatus according to claim 4, further comprising
a position acquisition unit periodically acquiring position information of each of the plurality of self-driving vehicles at a predetermined time interval,
wherein the route exclusion unit specifies, based on the position information, a partial portion of the first guidance route when the corresponding self-driving vehicle finishes traveling of the partial portion of the first guidance route, and then deactivates, for the partial portion of the first guidance route, the setting of the first guidance route.

6. The parking assist apparatus according to claim 3, wherein
the route generation unit sets, in map information including positions of multiple paths included in the parking lot, one of the multiple paths, which is included in the first guidance route, to an unavailable path, and generates the second guidance route to not include the unavailable path.

7. The parking assist apparatus according to claim 1, wherein
the parking lot includes an alighting area where a user alights from each of the plurality of self-driving vehicles, a parking area where each of the plurality of self-driving vehicles is parked, and a boarding area where the user boards on each of the plurality of self-driving vehicles,
before one of the plurality of self-driving vehicles starts to move from the alighting area to the parking area by the self-driving, the route generation unit generates the guidance route for the one of the plurality of self-driving vehicles to not overlap with the guidance route of each of the remaining self-driving vehicles, and
the route transmission unit transmits the generated guidance route to the one of the plurality of self-driving vehicles.

8. The parking assist apparatus according to claim 7, wherein
before one of the plurality of self-driving vehicles starts to move from the parking area to the boarding area by the self-driving, the route generation unit generates the guidance route for the one of the plurality of self-driving vehicles to not overlap with the guidance route of each of the remaining self-driving vehicles, and
the route transmission unit transmits the generated guidance route to the one of the plurality of self-driving vehicles.

9. The parking assist apparatus according to claim 1, wherein
the plurality of self-driving vehicles include a first vehicle and a second vehicle, and
when the second vehicle requests a parking assist after the guidance route of the first vehicle is generated, the route generation unit generates the guidance route of the second vehicle to not overlap with the guidance route of the first vehicle without changing the guidance route of the first vehicle.

10. The parking assist apparatus according to claim 3, further comprising
a memory that stores map information of the parking lot,
wherein
the map information stored in the memory includes availability information indicating whether each path included in the parking lot is available as the guidance route,
the route generation unit sets one or more paths included in the first guidance route to be unavailable, and sets remaining paths in the parking lot as available, and
the route generation unit generates the second guidance route to include only the path that is set to be available.

11. A parking assist method executed by a parking assist apparatus that assists a vehicle parking, the parking assist method comprising:
generating a guidance route for each of a plurality of self-driving vehicles existing in a parking lot, the guidance routes of the plurality of self-driving vehicles being generated to not overlap with one another, each of the plurality of self-driving vehicles being capable of executing a self-driving along the corresponding guidance route;
in response to determining that the guidance route of one of the plurality of self-driving vehicles to be generated overlaps with the guidance route of another one of the plurality of self-driving vehicles that has been generated, canceling a generation of the guidance route for the one of the plurality of self-driving vehicles; and
transmitting the guidance route to the corresponding self-driving vehicle, which plans to travel along the guidance route, when the guidance route is generated for the corresponding self-driving vehicle.

12. A parking assist apparatus assisting a vehicle parking, the parking assist apparatus comprising:
a processor; and
a non-transitory tangible storage medium storing instruction to be executed by the processor,
wherein
the instructions include:
generating a guidance route for each of a plurality of self-driving vehicles existing in a parking lot, the guidance routes of the plurality of self-driving vehicles being generated to not overlap with one another, each of the plurality of self-driving vehicles being capable of executing a self-driving along the corresponding guidance route;
in response to determining that the guidance route of one of the plurality of self-driving vehicles to be generated overlaps with the guidance route of another one of the plurality of self-driving vehicles that has been generated, canceling a generation of the guidance route for the one of the plurality of self-driving vehicles; and
transmitting the guidance route to the corresponding self-driving vehicle, which plans to travel along the guidance route, when the guidance route is generated for the corresponding self-driving vehicle.
